(19) United States
(12) Patent Application Publication
(10) Pub. No.: US 2005/0264895 A1
(43) Pub. Date: Dec. 1, 2005

(54) Lens member having a light shading function

(76) Inventor: Sheng-Jui Chao, Taichung (TW)

Correspondence Address: GALLAGHER & LATHROP, A PROFESSIONAL CORPORATION, 601 CALIFORNIA ST, SUITE 1111, SAN FRANCISCO, CA, 94108, US

(21) Appl. No.: 11/097,789

(22) Filed: Apr. 1, 2005

(30) Foreign Application Priority Data
May 27, 2004 (TW) 093115105

(51) Int. Cl. G02B 3/00; G02F 1/1335; G02B 7/00; G02B 9/00; G02B 11/00

(52) U.S. Cl. 359/642

(57) ABSTRACT

A lens member includes a light-transmissive lens, and a light-shading layer. The light-transmissive lens has a first face, a second face opposite to the first face, a peripheral side surface extending between the first and second faces, and an effective light-transmissive region formed between the first and second faces within the peripheral side surface. The light-shading layer has a light-shading portion directly bonded to the first face of the lens, and has an outer peripheral end proximate to the peripheral side surface of the lens, and an inner peripheral end defining a first hole within the outer peripheral end. The first hole substantially corresponds to the effective light-transmissive region of the lens.

### CROSS-REFERENCE TO RELATED APPLICATION

This application claims priority of Taiwanese Application No. 093115105, filed on May 27, 2004.

### BACKGROUND OF THE INVENTION

1. Field of the Invention

The invention relates to a lens member, more particularly to a lens member having a light-shading function.

2. Description of the Related Art

Referring to FIGS. 1 and 2, in a conventional optical instrument, a light-shading sheet 2 is disposed between two lenses 1 so as to shade the light outside an effective light-transmissive region of the lens 1. During installation, a vacuum pickup device (not shown) is required to pick up and to dispose the lenses 1 and the light-shading sheet 2 alternately into a lens barrel 3. Therefore, the installation is a time-wasting procedure. Additionally, the optical characteristics of the optical instrument can be affected adversely due to shifting of the light-shading sheet 2 away from the lenses 1 or due to loose attachment of the lenses 1 and the light-shading sheet 2 to each other.

### SUMMARY OF THE INVENTION

The object of the present invention is to provide a lens member having a light-shading function, which can overcome the aforesaid disadvantages of the prior art.

The lens member according to this invention includes a light-transmissive lens, and a light-shading layer. The light-transmissive lens has a first face, a second Face opposite to the first face, a peripheral side surface extending between the first and second faces, and an effective light-transmissive region formed between the first and second faces within the peripheral side surface. The light-shading layer has a light-shading portion directly bonded to the first face of the lens, and has an outer peripheral end proximate to the peripheral side surface of the lens, and an inner peripheral end defining a first hole within the outer peripheral end. The first hole substantially corresponds to the effective light-transmissive region of the lens.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded sectional view of a conventional optical instrument;

FIG. 2 is a sectional view of the conventional optical instrument after assembly;

FIG. 3 is a sectional view of the first preferred embodiment of a lens member according to this invention;

FIG. 4 is a fragmentary enlarged sectional view of the first preferred embodiment;

FIG. 5 is a fragmentary sectional view illustrating how the first preferred embodiment is made;

FIG. 6 is a sectional view of the second preferred embodiment of a lens member according to this invention; and

FIG. 7 is a sectional view of the third preferred embodiment of a lens member according to this invention.

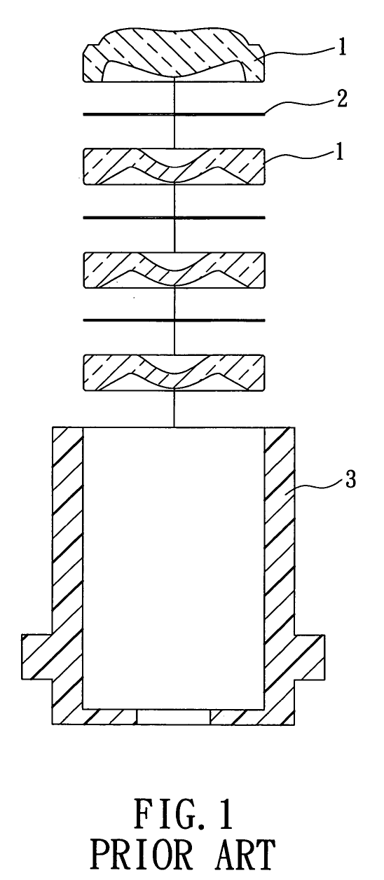

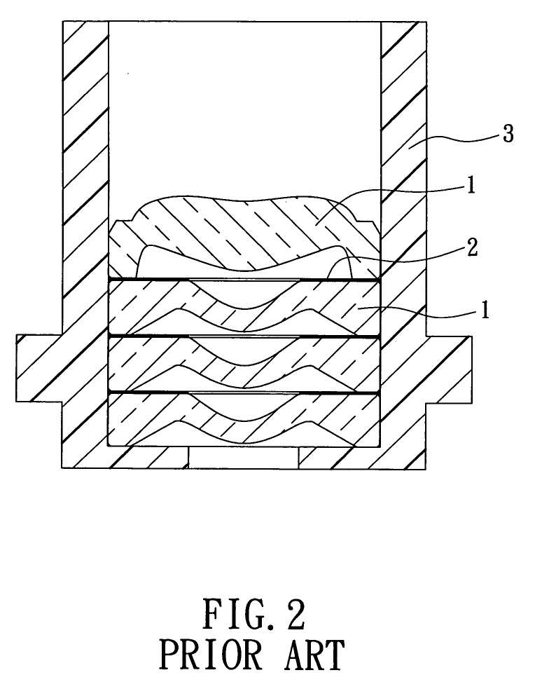

### DETAILED DESCRIPTION OF THE PREFERRED EMBODIMENTS

Before the present invention is described in greater detail, it should be noted that like elements are denoted by the same reference numerals throughout the disclosure.

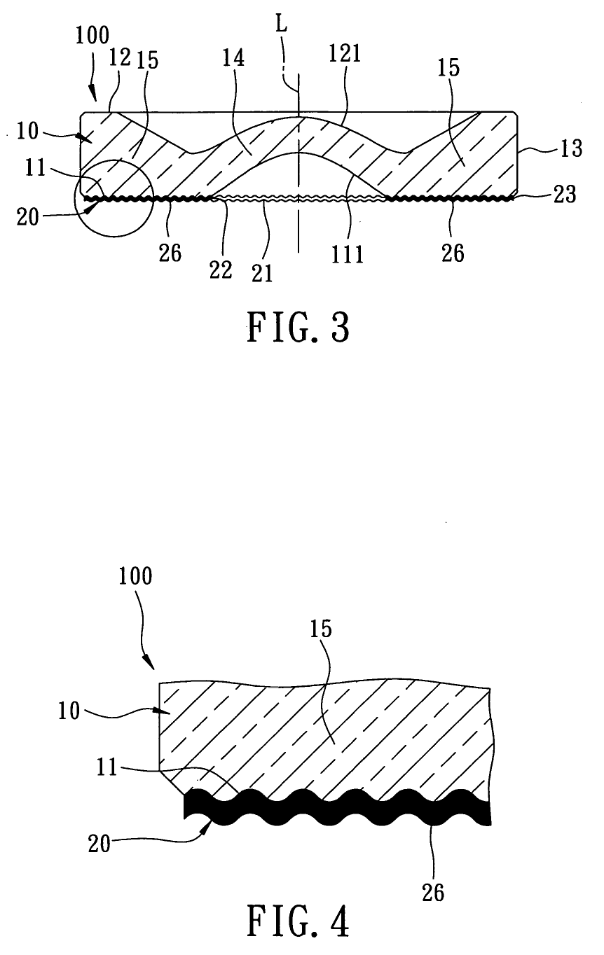

Referring to FIGS. 3 and 4, the first preferred embodiment of the lens member 100 having a light-shading function according to this invention is shown to include a light-transmissive lens 10, and a light-shading layer 20.

The light-transmissive lens 10 is made of a light-transmissive resin, and has a first face 11 proximate to the light-shading layer 20, a second face 12 opposite to the first face 11, a central axis (L), a peripheral side surface 13 extending between the first and second faces 11,12, and an effective light-transmissive region 14 formed between the first and second faces 11, 12 within the peripheral side surface 13. The first face 11 has a first light-transmissive portion 111 formed according to optical design requirements. The second face 12 has a second light-transmissive portion 121 opposite and corresponding to the first light-transmissive portion 111 and formed according to the optical design requirements.

The light-shading layer 20 used in this preferred embodiment is a product of SOMARU, Japan (Model No. B-R 90MD), which is made by blending polyester with carbon black. The light-shading layer 20 has a first light-shading portion 26 directly bonded to the first face 11 of the lens 10 by fusion bonding, and has an outer peripheral end 23 proximate to the peripheral side surface 13 of the lens 10, and an inner peripheral end 22 defining a first hole 21 within the outer peripheral end 23. The first hole 21 substantially corresponds to the effective light-transmissive region 14 of the lens 10. Therefore, the lens 10 has the effective light-transmissive region 14 and a non-effective region 15 surrounding the effective light-transmissive region 14. In other words, the non-effective region 15 is defined by the portions of the lens 10 other than the effective light-transmissive region. The light-shading layer 20 is directly bonded to the non-effective region 15. Furthermore, in the preferred embodiment, the light-shading layer 20 has two opposite rough surfaces with an average roughness of 0.77 um.

In the lens member 100 of this invention, the light-shading layer 20 is bonded directly to the lens 10. The effective light-transmissive region 14 of the lens 10 can be provided by forming the first hole 21 in the light-shading layer 20. Therefore, the lens member 100 can be installed on an optical instrument with relative ease as compared to the prior art. The aforesaid disadvantages of the prior art are thus avoided.

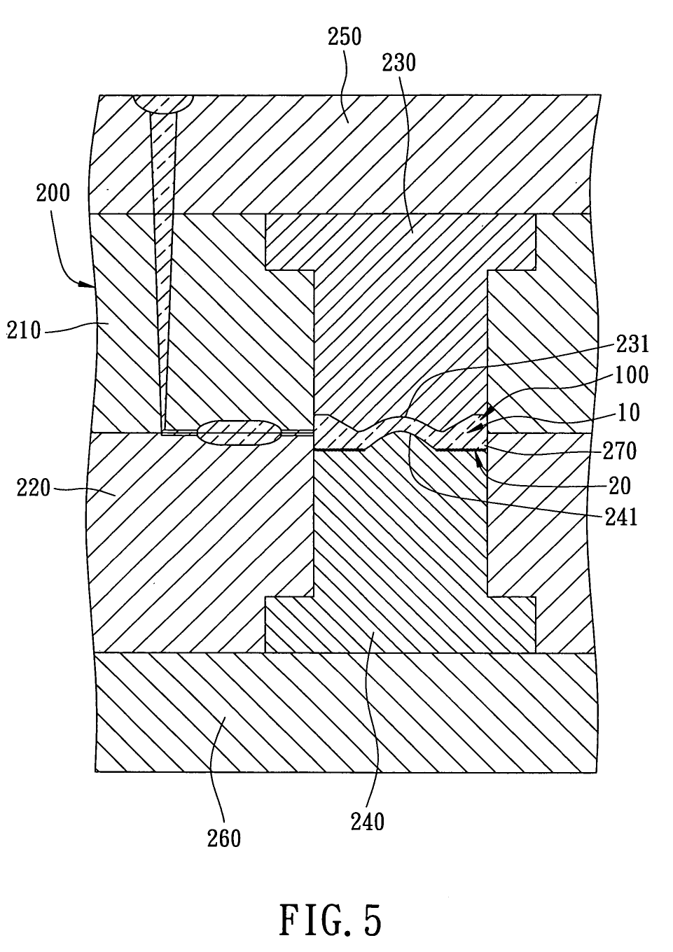

Referring to FIG. 5, the lens member 100 can be made by molding using a molding device 200. The molding device 200 includes an upper shaping plate 210, a lower shaping plate 220, a plurality of upper and lower mold cores 230,240, and upper and lower mold plates 250,260 mounted on the upper and lower shaping plates 210,220, respectively, and opposite to each other for positioning the upper and lower mold cores 230,240. Each upper mold core 230 has an upper molding surface 231, whereas each lower mold core 240 has a lower molding surface 241 cooperating with the corresponding upper molding surface 231 to define a mold cavity 270.

When the molding device 200 is opened, the light-shading layer 20 is positioned at the upper mold core 230 or at the lower mold core 240. When the molding device 200 is closed, the light-transmissive resin is injected into the mold cavity 270 so as to mold the lens 10, which is integrated with the light-shading layer 20, to form the lens member 100.

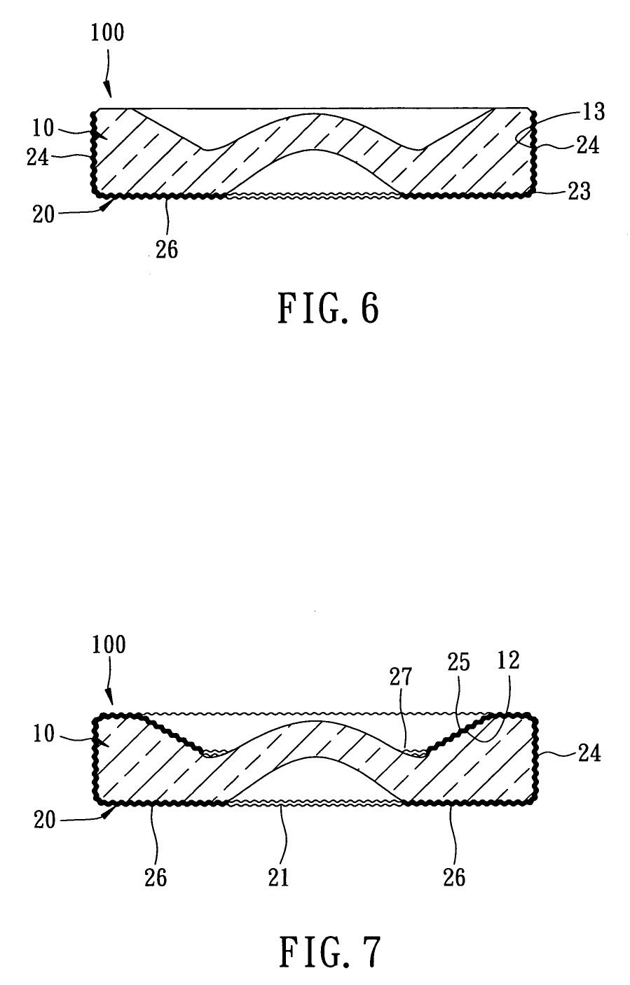

Referring to FIG. 6, the second preferred embodiment of the lens member 100 of this invention is similar to the first preferred embodiment except that, aside from the first light-shading portion 26, the light-shading layer 20 further includes a second light-shading portion 24 connected to the outer peripheral end 23 of the first light-shading portion 26 and directly bonded to the peripheral side surface 13 of the lens 10 by fusion bonding.

Referring to FIG. 7, the third preferred embodiment of the lens member 100 of this invention is similar to the second preferred embodiment except that, aside from the first and second light-shading portions 26,24, the light-shading layer 20 further includes a third light-shading portion 25 connected to the second light-shading portion 24 and directly bonded to the second face 12 of the lens 10 by fusion bonding. The third light-shading portion 25 defines a second hole 27 substantially corresponding to the first hole 21.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A lens member having a light-shading function, comprising:
a light-transmissive lens including a first face, a second face opposite to said first face, a peripheral side surface extending between said first and second faces, and an effective light-transmissive region formed between said first and second faces within said peripheral side surface; and
a light-shading layer including a first light-shading portion directly bonded to said first face of said lens, and including an outer peripheral end proximate to said peripheral side surface of said lens, and an inner peripheral end defining a first hole within said outer peripheral end, said first hole substantially corresponding to said effective light-transmissive region of said lens.

2. The lens member as claimed in claim 1, wherein said light-shading layer is bonded to said lens by fusion bonding.

3. The lens member as claimed in claim 1, wherein said lens includes a resin.

4. The lens member as claimed in claim 3, wherein said light-shading layer includes polyester.

5. The lens member as claimed in claim 1, wherein said light-shading layer further includes a second light-shading portion connected to said outer peripheral end of said first light-shading portion and directly bonded to said peripheral side surface of said lens.

6. The lens member as claimed in claim 5, wherein said light-shading layer further includes a third light-shading portion connected to said second light-shading portion and directly bonded to said second face of said lens, said third light-shading portion defining a second hole substantially corresponding to said first hole.

7. A lens member having a light-shading function, comprising:
a light-transmissive lens including an effective light-transmissive region and a non-effective region surrounding said effective light-transmissive region; and
a light-shading layer directly bonded to said non-effective region.

8. The lens member as claimed in claim 7, wherein said light-transmissive lens further includes a first face proximate to said light-shading layer, a second face opposite to said first face, and a peripheral side surface extending between said first and second faces, said effective light-transmissive region being formed between said first and second faces within said peripheral surface, portions of said lens other than said effective light-transmissive region defining said non-effective region.
